(19) United States
(12) Patent Application Publication
(10) Pub. No.: US 2012/0293436 A1
(43) Pub. Date: Nov. 22, 2012

(54) APPARATUS, METHOD, COMPUTER PROGRAM AND USER INTERFACE

(75) Inventors: Andre Dolenc, Espoo (FI); Anping Zhao, Beijing (CN); Erkki Riekkola, Vantaa (FI)

(73) Assignee: NOKIA CORPORATION, Espoo (FI)

(21) Appl. No.: 13/519,744

(22) PCT Filed: Dec. 29, 2009
(86) PCT No.: PCT/CN09/76215

§ 371 Date: Jun. 28, 2012

(51) Int. Cl. G06F 3/041

(52) U.S. Cl. 345/173

(57) ABSTRACT

An apparatus, method, computer program and user interface, the apparatus comprising: at least one processor: and at least one memory including computer program code; wherein the at least one memory and the computer program code are configured to, with the at least one processor, enable the apparatus to; provide an active area of a touch sensitive display and an inactive area of the touch sensitive display such that in response to the detection of a user input beginning in the active area, a first function is performed and in response to the detection of a user input beginning in the inactive area the first function is not performed; and provide a display area of the touch sensitive display configured to display content where the display area overlaps at least a portion of the active area and the inactive area, wherein the location of the active area is invariant with respect to performance of the first function.

### FIELD OF THE INVENTION

Embodiments of the present invention relate to an apparatus, method, computer program and user interface. In particular, they relate to an apparatus, method, computer program and user interface for enabling a user to manipulate content such as images.

### BACKGROUND TO THE INVENTION

Touch sensitive displays for displaying content such as text or images are well known. It is useful to enable a user to manipulate the content displayed on the display, for example, by altering the scale of the content or by scrolling through the content. It is useful for the inputs for controlling the manipulation of the content to be simple and intuitive for the user.

### BRIEF DESCRIPTION OF VARIOUS EMBODIMENTS OF THE INVENTION

According to various, but not necessarily all, embodiments of the invention there is provided an apparatus comprising: at least one processor: and at least one memory including computer program code; wherein the at least one memory and the computer program code are configured to, with the at least one processor, enable the apparatus to; provide an active area of a touch sensitive display and an inactive area of the touch sensitive display such that in response to the detection of a user input beginning in the active area, a first function is performed and in response to the detection of a user input beginning in the inactive area the first function is not performed; and provide a display area of the touch sensitive display configured to display content where the display area overlaps at least a portion of the active area and the inactive area; wherein the location of the active area is invariant with respect to performance of the first function.

In some embodiments of the invention the display area may comprise the entire touch sensitive display.

In some embodiments of the invention the content displayed in the display area might not provide an indication of the first function.

In some embodiments of the invention the at least one memory and the computer program code may be configured to, with the at least one processor, enable the apparatus to; enable a second function to be performed in response to the detection of a user input beginning in the inactive area of the touch sensitive display.

In some embodiments of the invention the at least one memory and the computer program code may be configured to, with the at least one processor, enable the apparatus to; provide a further active area of the touch sensitive display such that in response to the detection of a user input beginning in the further active area a third function is performed. The third function may be the reverse of the first function.

In some embodiments of the invention at least one of the functions may comprise changing the scale of the content displayed in the display area. In some embodiments of the invention at least one of the functions may comprise scrolling though the content displayed in the display area.

In some embodiments of the invention the function performed may depend upon the type of user input detected.

In some embodiments of the invention the detected user input may last for at least a predetermined amount of time.

In some embodiments of the invention the active areas may comprise an edge portion of the touch sensitive display. In some embodiments of the invention the active areas may comprise a corner of the touch sensitive display.

According to various, but not necessarily all, embodiments of the invention there is provided a method comprising; configuring a touch sensitive display to provide an active area of the touch sensitive display and an inactive area of the touch sensitive display; configuring a touch sensitive display to provide a display area of the touch sensitive display for displaying content where the display area overlaps at least a portion of the active area and the inactive area; detecting a user input and determining whether the user input began in the active area or the inactive area wherein in response to the detection of a user input beginning in the active area, a first function is performed and in response to the detection of a user input beginning in the inactive area the first function is not performed; and wherein the location of the active area is invariant with respect to performance of the first function.

According to various, but not necessarily all, embodiments of the invention there is provided a computer program comprising computer program instruction means configured to control an apparatus, the apparatus comprising a touch sensitive display and at least one processor the program instructions enabling, when loaded into the at least one processor; configuring the touch sensitive display to provide an active area of the touch sensitive display and an inactive area of the touch sensitive display; configuring the touch sensitive display to provide a display area of the touch sensitive display configured to display content where the display area overlaps at least a portion of the active area and the inactive area: detecting a user input and determining whether the user input began in the active area or the inactive area wherein in response to the detection of a user input beginning in the active area, a first function is performed and in response to the detection of a user input beginning in the inactive area the first function is not performed; and wherein the location of the active area is invariant with respect to performance of the first function.

In some embodiments of the invention the computer program may comprise program instructions for causing a computer to perform the method as described above.

In some embodiments of the invention there may be provided a physical entity embodying the computer program as described above.

In some embodiments of the invention there may be provided an electromagnetic carrier signal carrying the computer program as described above.

According to various, but not necessarily all, embodiments of the invention there is provided a user interface comprising: a touch sensitive display: wherein the touch sensitive display is configured to provide an active area of the touch sensitive display and an inactive area of the touch sensitive display such that, in response to the detection of a user input beginning in the active area, a first function is performed and in response to the detection of a user input beginning in the inactive area the first function is not performed; and provide a display area of the touch sensitive display configured to display content where the display area overlaps at least a portion of the active area and the inactive area; wherein the location of the active area is invariant with respect to performance of the first function.

According to various, but not necessarily all, embodiments of the invention there is provided an apparatus comprising: means for configuring a touch sensitive display to provide an active area of the touch sensitive display and an inactive area of the touch sensitive display; means for configuring a touch sensitive display to provide a display area of the touch sensitive display for displaying content where the display area overlaps at least a portion of the active area and the inactive area; means for detecting a user input and determining whether the user input began in the active area or the inactive area wherein in response to the detection of a user input beginning in the active area, a first function is performed and in response to the detection of a user input beginning in the inactive area the first function is not performed; and wherein the location of the active area is invariant with respect to performance of the first function.

The apparatus may be for wireless communications.

### BRIEF DESCRIPTION OF THE DRAWINGS

For a better understanding of various examples of embodiments of the present invention reference will now be made by way of example only to the accompanying drawings in which:

FIG. 1 schematically illustrates an apparatus according to an embodiment of the invention;

FIG. 2 is a block diagram which schematically illustrates a method according to an embodiment of the invention;

FIG. 3 illustrates a first embodiment of the invention in use;

FIG. 4 illustrates a second embodiment of the invention in use;

FIG. 5 is a block diagram which schematically illustrates a method according to the second embodiment of the invention;

FIG. 6 illustrates a third embodiment of the invention in use;

FIGS. 7A to 7C illustrate a fourth embodiment of the invention in use; and

FIGS. 8A to 8C illustrate a fifth embodiment of the invention in use.

### DETAILED DESCRIPTION OF VARIOUS EMBODIMENTS OF THE INVENTION

The Figures illustrate an apparatus 1 comprising: at least one processor 3: and at least one memory 5 including computer program code 9; wherein the at least one memory 5 and the computer program code 9 are configured to, with the at least one processor 3, enable the apparatus 1 to; provide an active area 53A to 53D of a touch sensitive display 15 and an inactive area 57 of the touch sensitive display 15 such that in response to the detection of a user input beginning in the active area 53A to 53D, a first function is performed and in response to the detection of a user input beginning in the inactive area 57 the first function is not performed; and provide a display area 61 of the touch sensitive display 15 configured to display content 63 where the display area overlaps at least a portion of the active area 53A to 53D and the inactive area 57; wherein the location of the active area 53A to 53D is invariant with respect to performance of the first function.

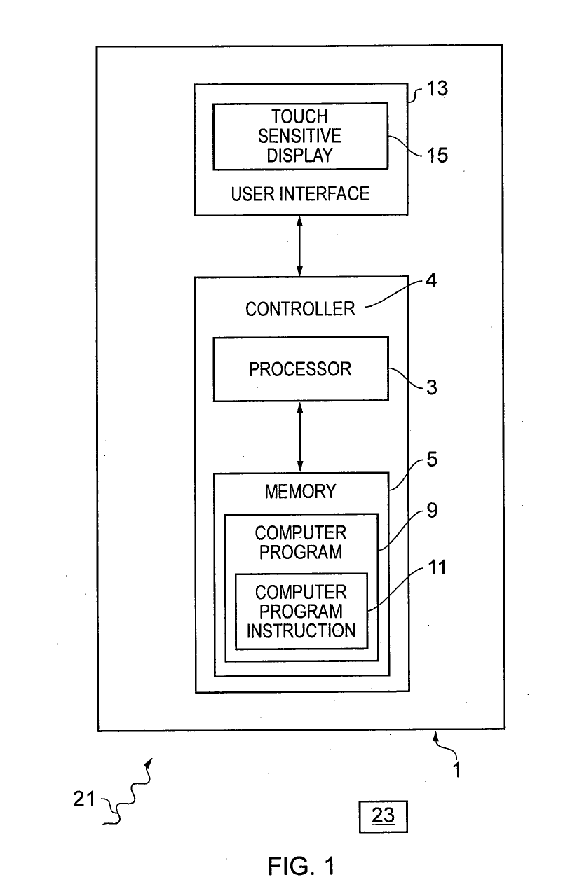

FIG. 1 schematically illustrates an apparatus 1 according to an embodiment of the invention. The apparatus 1 may be an electronic apparatus. The apparatus 1 may be, for example, a mobile cellular telephone, a personal computer, a camera, a personal digital assistant, a personal music player or any other apparatus that enables content such as text or images to be presented on a display 15. The apparatus 1 may be a handheld apparatus 1 which can be carried in a user's hand, handbag or jacket pocket for example.

Only features referred to in the following description are illustrated. It should, however, be understood that the apparatus 1 may comprise additional features that are not illustrated. For example, in embodiments of the invention where the apparatus 1 is a mobile cellular telephone, the apparatus 1 may also comprise a transmitter and receiver configured to enable wireless communication.

The illustrated apparatus 1 comprises: a user interface 13 and a controller 4. In the illustrated embodiment the controller 4 comprises at least one processor 3 and a memory 5 and the user interface 13 comprises a touch sensitive display 15. The user interface 13 provides means for enabling a user to make inputs which may be used to control the apparatus 1.

The controller 4 provides means for controlling the apparatus 1. The controller 4 may be implemented using instructions that enable hardware functionality, for example, by using executable computer program instructions 11 in one or more general-purpose or special-purpose processors 3 that may be stored on a computer readable storage medium 23 (e.g. disk, memory etc) to be executed by such processors 3.

The controller 4 may be configured to control the apparatus 1 to perform a plurality of different functions. For example, where the apparatus 1 is a mobile cellular telephone the controller 4 may be configured to control the apparatus 1 to make and receive telephone calls and also to perform other functions such as send messages or access communication networks such as local area networks or the internet.

The controller 4 may also be configured to enable the apparatus 1 to configure the touch sensitive display 15 to provide an active area 53A to 53D of the touch sensitive display 15 and an inactive area 57 of the touch sensitive display 15; configure the touch sensitive display 15 to provide a display area 61 of the touch sensitive display 15 configured to display content 63 where the display area 61 overlaps at least a portion of the active area 53A to 53D and the inactive area 57: detect a user input and determine whether the user input began in the active area 53A to 53D or the inactive area 57 wherein in response to the detection of a user input beginning in the active area 53A to 53D, a first function is performed and in response to the detection of a user input beginning in the inactive area 57 the first function is not performed; and wherein the location of the active area is 53A to 53D invariant with respect to performance of the first function.

The at least one processor 3 is configured to receive input commands from the user interface 13 and also to provide output commands to the user interface 13. The at least one processor 3 is also configured to write to and read from the memory 5.

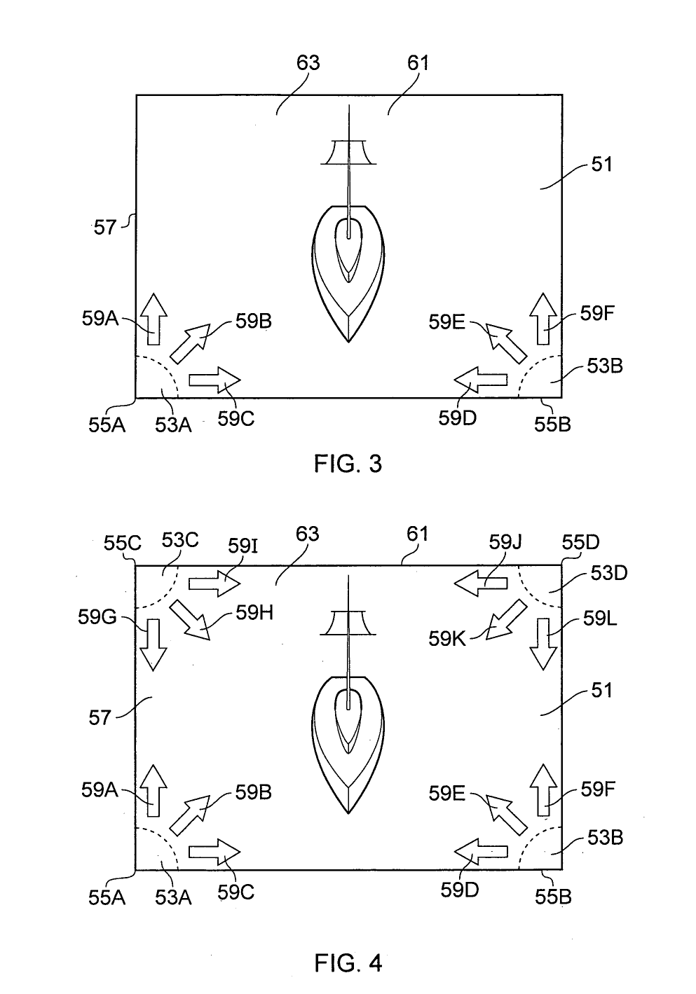

The touch sensitive display 15 is configured to enable information to be displayed in the display area 61. The information may comprise content 63 such as text or images. The touch sensitive display 15 may also be configured to display graphical user interfaces such as those illustrated in FIGS. 3, 4, 6, 7A to 7C and 8A to 8C.

The touch sensitive display 15 is configured to detect touch inputs. A user of the apparatus 1 may make a touch input by actuating the surface of the touch sensitive display 15. The surface of the touch sensitive display 15 may be actuated by a user using their finger or thumb or any other suitable object such as a stylus to physically make contact with the surface. In some embodiments of the invention the user may also be able to actuate the touch sensitive display 15 by bringing their finger thumb or stylus close to the surface of the touch sensitive display 15. The touch sensitive display 15 may be a capacitive touch sensitive display, a resistive touch sensitive display or any type of touch sensitive display.

The touch sensitive display 15 may be configured to detect different types of user input. For example, the touch sensitive display 15 may be configured to detect trace inputs or a long press input or any other type of actuation or combination or sequence of actuations. A user may make a trace input by actuating the surface of the touch sensitive display 15 and then dragging their finger, thumb or stylus across the surface. A user may make a long press input by actuating the same region of the surface of the touch sensitive display 15 for longer than a predetermined amount of time.

The output of the touch sensitive display 15 is provided as an input to the controller 4 and is dependent upon the type of actuation of the touch sensitive display 15 and also the location of the area actuated by the user input. The controller 4 may be configured to determine the type of input which has been made and also the location of the user input and enable the appropriate function to be performed in response to the detected input.

In some embodiments of the invention the user interface 13 may also comprise additional user input devices such as a key pad, a joy stick, or any other user input device which enables a user of the apparatus 1 to input information into the apparatus 1.

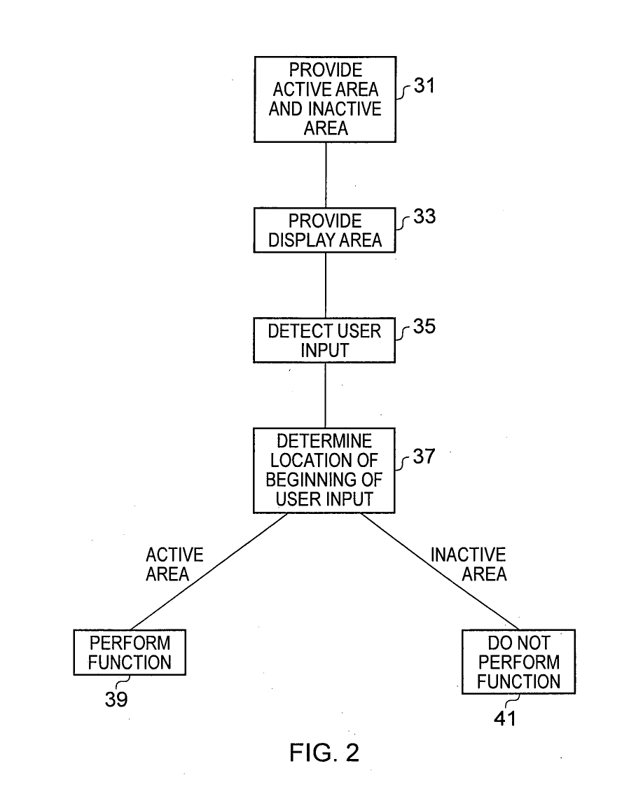

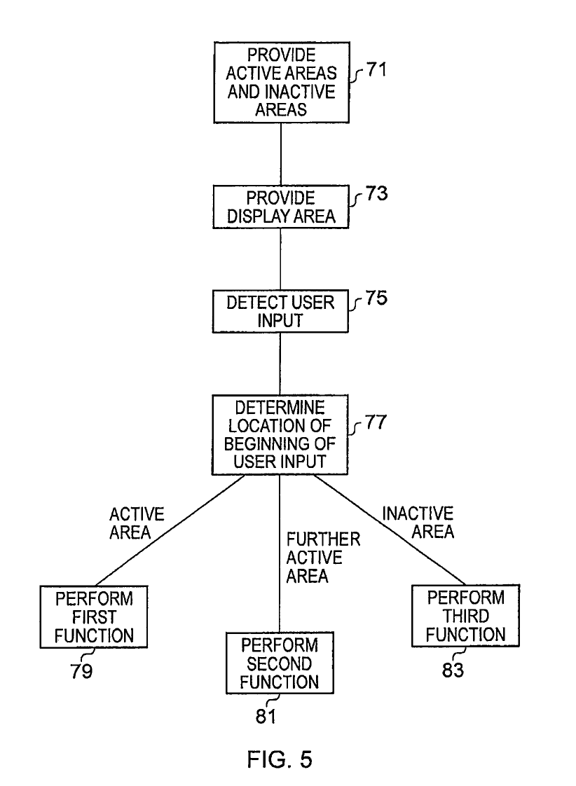

The memory 5 stores a computer program code 9 comprising computer program instructions 11 that control the operation of the apparatus 1 when loaded into the at least one processor 3. The computer program instructions 11 provide the logic and routines that enables the apparatus 1 to perform the methods illustrated in FIGS. 2 and 5. The at least one processor 3 by reading the memory 5 is able to load and execute the computer program 9.

The computer program instructions 11 may provide computer readable program means configured to control the apparatus 1. The program instructions 11 may provide, when loaded into the controller 4; means for configuring the touch sensitive display 15 to provide an active area 53A to 53D of the touch sensitive display 15 and an inactive area 57 of the touch sensitive display 15; means for configuring the touch sensitive display 15 to provide a display area 61 of the touch sensitive display 15 configured to display content 63 where the display area 61 overlaps at least a portion of the active area 53A to 53D and the inactive area 57: and means for detecting a user input and determining whether the user input began in the active area 53A to 53D or the inactive area 57 wherein in response to the detection of a user input beginning in the active area 53A to 53D, a first function is performed and in response to the detection of a user input beginning in the inactive area 57 the first function is not performed; and wherein the location of the active area 53A to 53D is invariant with respect to performance of the first function.

The computer program code 9 may arrive at the apparatus 1 via any suitable delivery mechanism 21. The delivery mechanism 21 may be, for example, a computer-readable storage medium, a computer program product 23, a memory device, a record medium such as a CD-ROM or DVD, an article of manufacture that tangibly embodies the computer program code 9. The delivery mechanism may be a signal configured to reliably transfer the computer program code 9. The apparatus 1 may propagate or transmit the computer program code 9 as a computer data signal.

Although the memory 5 is illustrated as a single component it may be implemented as one or more separate components some or all of which may be integrated/removable and/or may provide permanent/semi-permanent/dynamic/cached storage.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (e.g. Von Neumann)/parallel architectures but also specialized circuits such as field-programmable gate arrays (FPGA), application integration specific circuits (ASIC), signal processing devices and other devices. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

A method of controlling the apparatus 1, according to embodiments of the invention, is illustrated schematically in FIG. 2.

At block 31 the apparatus 1 is configured to provide an active area 53A to 53D of the touch sensitive display 15 and an inactive area 57 of the touch sensitive display 15. The active area 53A to 53D is associated with a first function such that the detection of a user input beginning in the active area 53A to 53D will enable the first function to be performed. Conversely the detection of a user input beginning in the inactive area 57 will not enable the first function to be performed.

The active area 53A to 53D and the inactive area 57 may be distinct from each other so that there is no overlap between the active area 53A to 53D and the inactive area 57.

In some embodiments of the invention a plurality of active areas 53A to 53D may be provided. In some embodiments of the invention each of the active areas 53A to 530 may be associated with the same function. In other embodiments of the invention some of the active areas 53A to 53D may be associated with different functions to other active areas 53A to 53D.

The active area 53A to 53D may be positioned on the touch sensitive display 15 so that it can be easily located by the user without any specific visual indications. For example the active areas may comprise edge portions of the touch sensitive display 15 or the corner portions 55A to 55D of the touch sensitive display 15. There is no requirement for any icons indicating the location of the active area 53A to 53D.

The location of the active areas 53A to 53D may be selectively determined by the user of the apparatus 1. For example a user may be able to select whether the active area is located in a left hand corner 55A, 55C or a right hand corner 55B, 55D of the touch sensitive display 15. This enables the user to program the apparatus 1 to be operable in the configuration which is most convenient for them. For example a left handed user may find it more convenient to locate the active areas 53A to 53D in a different location to a right handed user.

At block 33 the apparatus 1 is configured to provide a display area 61 of the touch sensitive display 15. The display area 61 is configured for displaying content 63. The content 63 may comprise, for example, images or text. The content 63 may be stored in the memory 5 of the apparatus 1. The content 63 may have been input by a user of the apparatus 1 or may be have been received by the apparatus 1.

The display area 61 may overlap both the active area 53A to 53D and the inactive area 57. In some embodiments of the invention the display area 61 may comprise the entire of the touch sensitive display 15.

At block 35 the controller 4 detects a user input made by actuating the touch sensitive display 15. The user input may be any type of user input, for example it may be a trace user input or it may be a long press input. At block 37 the controller 4 determines the location where the detected user input began. For example the controller 4 determines whether or not the input began in an active area 53A to 53D or an inactive area 57.

If it is determined that the user input began in an active area 53A to 53D then, at block 39, the function associated with the active area 53A to 53D is performed. Conversely if it is determined that the user input did not begin in the active area 53A to 53D then the process proceeds to step 41 and the function is not performed.

In embodiments of the invention where the detected user input is a trace user input the trace may extend across both the active 53A to 53D and the inactive area 57. In such embodiments the function performed will be determined by whether or not the trace began in the active area 53A to 53D.

The function performed may be performed on the content 63 which is displayed in the display area 61. For example, in some embodiments of the invention, the function may increase or decrease the scale of content 63 displayed in the display area 61. In other embodiments of the invention the function may enable the user to scroll across content 63 displayed in the display area 61.

The location of the active area 53A to 53D is invariant with respect to the performance of the function so that the location of the active area 53A to 53D does not change after the function has been performed.

In some embodiments of the invention the inactive area 57 may not be associated with any function so that the detection of a user input beginning in the inactive area 57 does not enable any function to be performed. In other embodiments of the invention the inactive area 57, or portions of the inactive area 57, may be associated with one or more other functions, which are different to the function associated with the active area 53A to 53D. In such embodiments the detection of a user input beginning in the inactive area 57 enables the other function to be performed.

The blocks illustrated in FIG. 2 may represent steps in a method and/or sections of code in the computer program 9. The illustration of a particular order to the blocks does not necessarily imply that there is a required or preferred order for the blocks and the order and arrangement of the block may be varied. Furthermore, it may be possible for some steps to be omitted.

FIG. 3 illustrates a user interface according to embodiments of the invention. The user interface comprises a touch sensitive display 15. The touch sensitive display comprises active areas 53A, 53B, an inactive area 57 and a display area 61.

In the embodiment illustrated in FIG. 3 the active area comprises two distinct active areas 53A, 53B one located in the lower left hand corner 55A and one located in the lower right hand corner 55B. It is to be appreciated that the active areas 53A, 53B could be located in other locations of the touch sensitive display 15. For example they could be located in any of the corners of the touch sensitive display 15. Also, in the illustrated embodiment, two active areas 53A, 53B are provided. In other embodiments of the invention any number of active areas 53A, 53B may be provided.

In the embodiment illustrated in FIG. 3 the active areas 53A, 53B are indicated by dashed lines for clarity. It is to be appreciated that in actual embodiments of the invention the dashed lines would not be displayed so that there would be nothing obscuring the content 63 displayed in the display area 61. In the illustrated embodiments there is no indication provided of the location of the active areas 53A, 53B.

In this particular embodiment both of the active areas 53A and 53B are associated with a first function so that the same function is performed if the user input begins in the lower left hand corner 55A or the lower right hand corner 55B.

The inactive area 57 comprises the rest of the touch sensitive display 15. The first function will not be performed if the detected user input begins in the inactive area 57.

In the embodiment illustrated in FIG. 3 the display area 61 comprises the whole of the touch sensitive display 15 so that content 63 may be displayed anywhere on the touch sensitive display 15 including the active areas 53A and 53B.

In the embodiment illustrated in FIG. 3 the first function may be performed in response the detection of a trace input which begins in any of the active areas 53A, 53B. The trace input may begin in one of the corners 55A, 55B and may extend in any direction out of the corners 55A, 55B as indicated by the arrows 59A to 59F.

In the illustrated embodiment the first function comprises changing the scale of the content 63 displayed in the display area 61. As the user makes a trace extending away from the corner 55A, 55B the scale of the content 63 displayed in the display area 61 increases. If the user reverses the trace back towards the corner 55A, 55B then the scale of the content 63 displayed decreases.

FIG. 4 illustrates a user interface according to second embodiment of the invention. As with the embodiment illustrated in FIG. 3 the user interface comprises a touch sensitive display 15. The touch sensitive display 15 comprises active areas 53A, 53B, an inactive area 57 and a display area 61. However in the embodiment illustrated in FIG. 4 further active areas 53C and 53D are also provided. The further active areas 53C and 53D are located in the upper left hand corner 55C and the upper right hand corner 55D respectively. The display area 61 overlaps the inactive area 57 and all of the active areas 53A to 53D so that it comprises the whole of the display 15.

A user may make an input starting in any of the corners 55A to 55D of the apparatus 1 and moving away from the respective corner 55A to 55D in a direction indicated generally by the arrows 59A to 59L.

In the illustrated embodiment the active areas 53A to 53D are indicated by dashed lines for clarity however it is to be appreciated that in embodiments of the invention the dashed lines would not be displayed so that there would be nothing obscuring the content 63 displayed in the display area 61.

In the embodiment illustrated in the FIG. 4 the active areas 53A and 53B are associated with a first function and the further active areas 53C and 53D are associated with a second, different function. In some embodiments of the invention the first and second functions may be the reverse of each other. For example, the first function associated with the active areas 53A and 53B, located in the lower corners 55A and 55B, may be increasing the scale of content 63 displayed in the display area 61 whereas the second function associated with the active areas 53C and 53D located in the upper corners 55C and 55D may be decreasing the scale of content 63 displayed in the display area 61.

In some embodiments of the invention the inactive area 57 may be associated with a third function, different to the first and second functions. For example the inactive area 57 may be associated with the function of scrolling to enable the user to scroll up and down or across the content 63 presented in the display area 61. To enable the scrolling function the user may make a trace input beginning in the inactive area 57. The scrolling may be in the same general direction as the trace.

FIG. 5 illustrates a method of controlling the apparatus 1 according to the embodiment illustrated in FIG. 4.

At block 71 the apparatus 1 is configured to provide the active areas 53A, 53B and the further active areas 53C, 53D and the inactive area 57 of the touch sensitive display 15. The active areas 53A, 53B are associated with a different function to the further active areas 53C, 53D. In some embodiments of the invention the inactive area 57 may also be associated with one or more functions.

The active areas 53A to 53D and the inactive area 57 may be distinct from each other so that there is no overlap between the active areas 53A to 53D and the inactive area 57.

Block 73 corresponds to block 33 of FIG. 2. At block 73 the apparatus 1 is configured to provide a display area 61 of the touch sensitive display 15 which is configured for displaying content 63. The content 63 may be, for example, images or text which may be stored in the memory 5 of the apparatus 1. The content may have been input by a user of the apparatus 1 or may be have been received by the apparatus 1.

The display area 61 may overlap both the active areas 53A to 53D and the inactive area 57. In some embodiments of the invention the display area 61 may comprise the entire of the touch sensitive display 15.

Block 75 corresponds to block 35 of FIG. 2. At block 75 the controller 4 detects a user input made by actuating the touch sensitive display 15. The user input may be any type of user input, such as a trace user input or a long press input. At block 77 the controller 4 determines the location where the detected user input began. For example the controller 4 determines whether the input began in an active area 53A, 53B, a further active area 53C, 53D or in the inactive area 57.

If it is determined that the user input began in an active area 53A, 53B then, at block 79, the first function is performed. If it is determined that the user input began in a further active area 53C, 53D then, at block 81, the first function is not performed but a second function is performed. If it is determined that the user input began in an inactive area 57 then, at block 83, neither the first function nor the second function is performed but a third, different function may be performed.

In embodiments of the invention where the detected user input is a trace user input the trace may extend across both an active area 53A to 53D and the inactive area 57. In such embodiments the function performed will be determined by the location of the beginning of the trace.

The blocks illustrated in FIG. 5 may represent steps in a method and/or sections of code in the computer program 9. The illustration of a particular order to the blocks does not necessarily imply that there is a required or preferred order for the blocks and the order and arrangement of the block may be varied. Furthermore, it may be possible for some steps to be omitted.

FIG. 6 illustrates a user interface according to another embodiment of the invention. As with the embodiment illustrated in FIGS. 3 and 4 the user interface comprises a touch sensitive display 15. The touch sensitive display 15 comprises active areas 53A, 53B, further active areas 53C, 53D and an inactive area 57. However in the embodiment illustrated in FIG. 6 third active areas 91A to 91D are provided. The third active areas 91A to 91D are located along the edges 93 of the touch sensitive display 15. The display area 61 overlaps the inactive area 57 and the active areas 53A to 53D and 91A to 91D so that it comprises the whole of the touch sensitive display 15.

In the embodiment illustrated in FIG. 6 the third active areas may overlap one or more of the other active areas 53A to 53D. For example, the edge portions 91A to 91D may extend in to the corner portions 55A to 55D. In such embodiments the function which is performed is determined by the location in which a user input begins and also by the type of user input. For example, a trace beginning in a corner portion 55A to 55D and extending in a general direction towards the centre of the display 15 may enable a first function to be performed whereas a trace input beginning in a corner portion 55A to 55D and extending in a general direction along the edge of the display 15 may enable a different function to be performed. In the illustrated embodiments, a trace beginning in a corner portion 55A to 55D and extending in a general direction towards the centre of the display 15 in a direction generally indicated by arrows 59B, 59E, 59H and 59K may enable the scale of the content 63 to be changed and a trace input beginning in a corner portion 55A to 55D and extending in a general direction along the edge of the display 15 in a direction generally indicated by arrows 59A, 59C, 59D, 59F, 59G, 59I, 59J and 59I may enable scrolling through the content. The scrolling may be in the general direction in which the trace input is made.

As in the previously illustrated embodiments the active areas 53A to 53D and 91A to 91D are indicated by dashed lines for clarity however it is to be appreciated that in embodiments of the invention the dashed lines would not be displayed so that there would be nothing obscuring the content 63 displayed in the display area 61.

The inactive area 57 may be associated with further function. For example the inactive area 57 may be associated with the function of hovering which enables the user to select items from the displayed content 63 or move a cursor through the content 63.

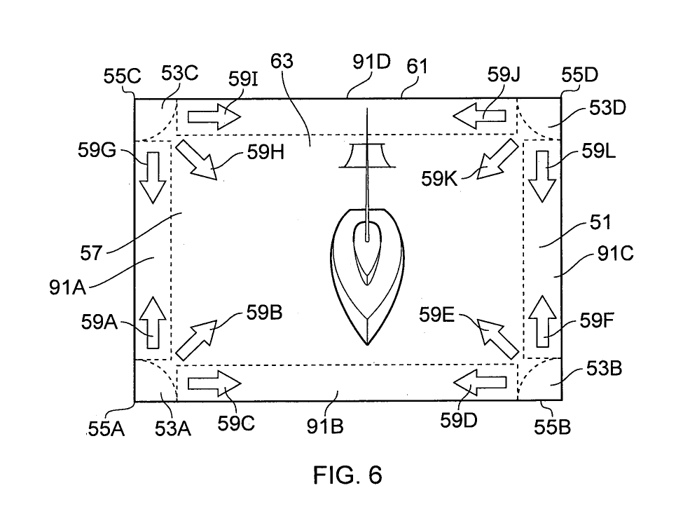

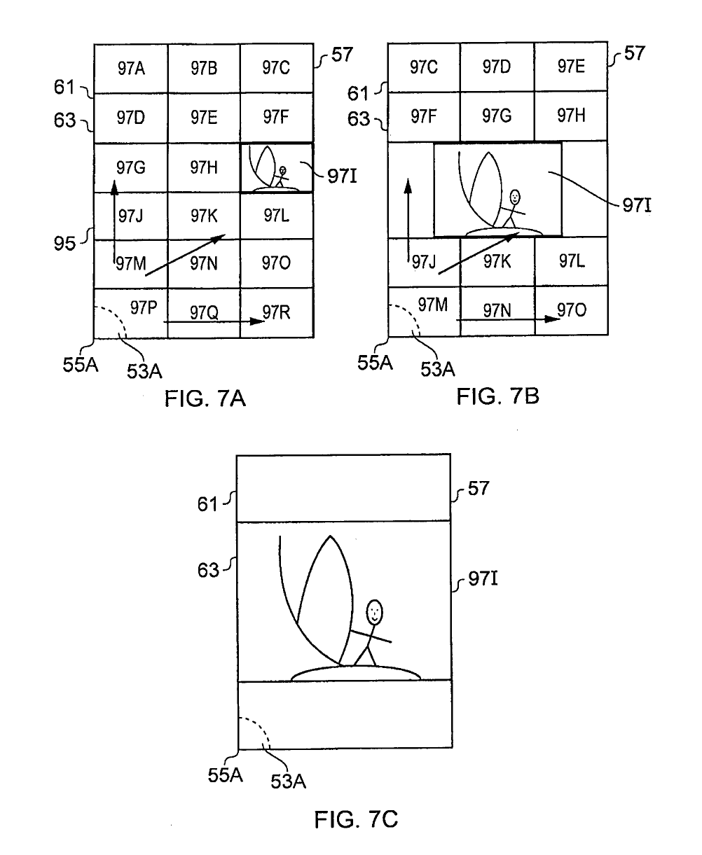

FIGS. 7A to 7C illustrate a user interface according to another embodiment of the invention. In this embodiment the touch sensitive display 15 comprises one active area 53A in the lower left hand corner 55A of the touch sensitive display 15. The inactive area 57 comprises the rest of the display 15. The display area 61 overlaps the inactive area 57 and the active area 53 to so that it comprises the whole of the touch sensitive display 15.

As in the previously illustrated embodiments the active area is indicated by dashed lines for clarity however it is to be appreciated that in embodiments of the invention the dashed lines would not be displayed so that there would be nothing obscuring the content 63 displayed in the display area 61.

In the embodiment illustrated in FIG. 7A the content 63 comprises a gallery 95 of images 97A to 97R. Each of the images 97A to 97R is presented the same size as each of the other images 97A to 97R.

In FIG. 7A the user has selected one of the images 97I. The user may select the image by making a user input in the area of the display where the image is presented, for example by making along tap input. The selected image is highlighted so that it may be visually distinguished from the other mages by the user. For example, the background to the image may be presented as a different color or the border around the image may be thicker than the border around the other images.

In FIG. 7B the scale of the selected image 97I has increased in response to a user input beginning in the active area 53A. The user input may comprise a trace beginning in the corner portion 55A and extending in the direction of any of the arrows 59A to 59C.

As the scale of the selected image has decreased some of the images 97A, 97B, 97P to 97R are no longer displayed in the display area 61 to create space in which the increased scale image 97I can be displayed.

In FIG. 7C the user has completed the input so that in the graphical user interface the selected image 97I is enlarged to fill the display area 61. The selected image 97I is the only image presented in the display area 61.

It is to be appreciated that in other embodiments of the invention illustrated in FIGS. 7A to 7C there could be any number of active areas for example, each of the four corners could be an active area

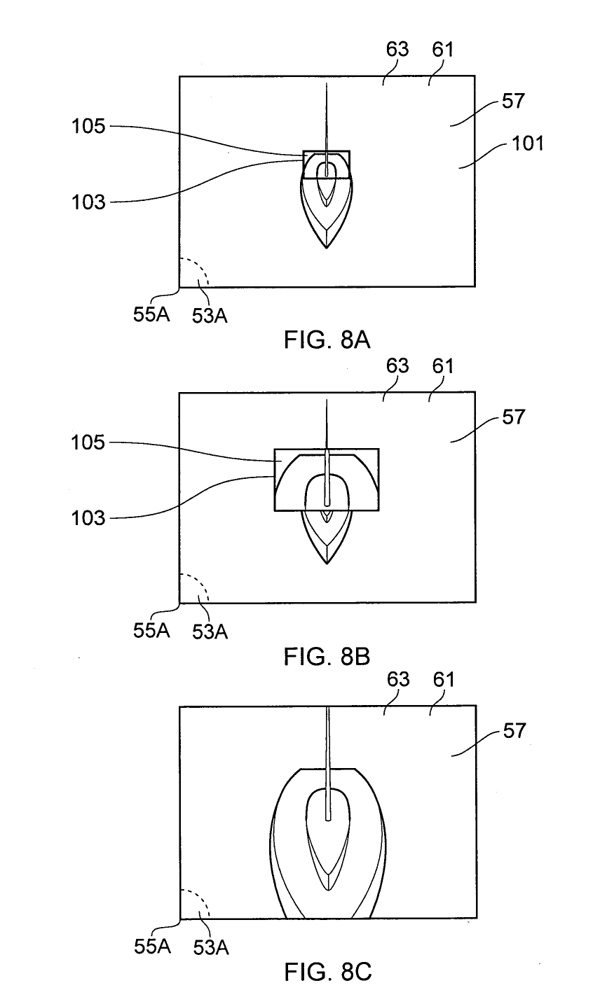

FIGS. 8A to 8C illustrate a user interface according to another embodiment of the invention. In this embodiment the touch sensitive display 15 comprises one active area 53A in the lower left hand corner 55A of the touch sensitive display 15. The inactive area 57 comprises the rest of the display 15. The display area 61 overlaps the inactive area 57 and the active area 53 to so that it comprises the whole of the touch sensitive display 15.

As in the previously illustrated embodiments the active area 53A is indicated by dashed lines for clarity however it is to be appreciated that in embodiments of the invention the dashed lines would not be displayed so that there would be nothing obscuring the content 63 displayed in the display area 61.

Embodiments of the invention provide the advantage that it enables a user to easily manipulate content because a dedicated area of the touch sensitive display 15 is associated with a function. As the dedicated area of the touch sensitive display 15 does not change when the function associated with the area is performed there is no need for any indication of the area to be provided. This enables the whole of the display 15 to be used to present content 63. There is no need for the presentation of additional information such as icons to instruct the user.

Furthermore, the user inputs required to manipulate the content 63 are simple and intuitive and may be made with a single digit. There is no need for a complicated sequence of inputs or for the display to be configured to detect multi-touch inputs. This also enables the apparatus 1 to be controlled using only one hand. For example the user may be able to hold the apparatus in the palm of their hand and make the inputs with the thumb of that hand.

Embodiments of the invention may also enable a user to operate the apparatus 1 simultaneously to performing another function. As no information is presented on the display indicative of the functions associated with an active area a user does not necessarily have to look at the apparatus 1 to control the apparatus. For example a user may be able to walk and use the apparatus at the same time. This may also be useful where the function associated with the active areas are not performed on the content displayed in the display area, for example, the function may be controlling the volume of an audio output provided by the apparatus.

In the embodiment illustrated in FIG. 8A the content 63 comprises an image 101. The image 101 is presented at a first resolution. The image 101 is displayed so that it covers the whole of the display area 61.

In FIG. 8A a first region 105 of the display 15 is indicated by the thick solid line 103. In other embodiments the first region may be indicated by a different means, for example a dashed line. In the illustrated embodiment the first region 105 is a rectangle and is presented in the centre of the display area 61.

In FIG. 8B the user has made a trace input beginning in the active area 53A. In response to this input the size of the first region 105 has increased. The scale of the portion of the image 101 displayed within the first region 105 has also increased. However the scale of the portion of the image 105 displayed outside the first region 105 has not increased. This means that the portion of the image 101 displayed within the first region 105 is presented at a first resolution and the portion of the image 101 displayed outside the first region 105 is displayed at a second resolution where the first resolution is finer than the second resolution.

In FIG. 8C the user has completed the trace input. Once the trace input has been completed the scale of the portion of the image 101 displayed outside the first region 105 is increased to match the scale of the portion of the image 101 displayed within the first region 105. The solid line 103 indicating the first region is no longer displayed so there is nothing displayed on the display 15 which obscures the view of the image 101.

Embodiments of the invention described in relation to FIGS. 8A to 8C provide the advantage that as the user is making the input only the portion of the image 101 within the first region 105 changes scale. This provides immediate feedback to the user as the user can easily see the change in scale of the image but it also reduces the processing power needed as only a portion of the image 101 is changing scale.

Although embodiments of the present invention have been described in the preceding paragraphs with reference to various examples, it should be appreciated that modifications to the examples given can be made without departing from the scope of the invention as claimed. For example in some embodiments of the invention the location of the active areas may depend on the orientation of the device. For example, if the apparatus is rotated through 90° the active areas may be repositioned so that the active area is always located in the bottom left hand corner of the display irrespective of whether the apparatus is in a landscape or portrait mode of operation. In embodiments where there is more than one active area, for example where an active area is located in each of the four corners the function associated with the area may change as the apparatus is rotated. This means that a lower corner as it appears to a user may always be associated with a first function and an upper corner may always be associated with a second function. This may make the apparatus more intuitive for a user to use

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. An apparatus comprising:
at least one processor: and
at least one memory including computer program code;
wherein the at least one memory and the computer program code are configured to, with the at least one processor, enable the apparatus to;
provide an active area of a touch sensitive display and an inactive area of the touch sensitive display such that in response to the detection of a user input beginning in the active area, a first function is performed and in response to the detection of a user input beginning in the inactive area the first function is not performed; and
provide a display area of the touch sensitive display configured to display content where the display area overlaps at least a portion of the active area and the inactive area;
wherein the location of the active area is invariant with respect to performance of the first function.

2. An apparatus as claimed in claim 1 wherein the display area comprises the entire touch sensitive display.

3. An apparatus as claimed in claim 1 wherein the content displayed in the display area does not provide an indication of the first function.

4. An apparatus as claimed in claim 1 wherein the at least one memory and the computer program code are configured to, with the at least one processor, enable the apparatus to; enable a second function to be performed in response to the detection of a user input beginning in the inactive area of the touch sensitive display.

5. An apparatus as claimed in claim 1 wherein the at least one memory and the computer program code are configured to, with the at least one processor, enable the apparatus to; provide a further active area of the touch sensitive display such that in response to the detection of a user input beginning in the further active area a third function is performed.

6. An apparatus as claimed in claim 5 wherein the third function is the reverse of the first function.

7. An apparatus as claimed in claim 1 wherein at least one of the functions comprises changing the scale of the content displayed in the display area.

8. An apparatus as claimed in claim 1 wherein at least one of the functions comprises scrolling though the content displayed in the display area.

9. An apparatus as claimed in claim 1 wherein the function performed depends upon the type of user input detected.

10. An apparatus as claimed in claim 1 wherein the detected user input lasts for at least a predetermined amount of time.

11. An apparatus as claimed in claim 1 wherein the active areas comprise an edge portion of the touch sensitive display.

12. An apparatus as claimed in claim 1 wherein the active areas comprise a corner of the touch sensitive display.

13. A method comprising;
configuring a touch sensitive display to provide an active area of the touch sensitive display and an inactive area of the touch sensitive display;
configuring a touch sensitive display to provide a display area of the touch sensitive display for displaying content where the display area overlaps at least a portion of the active area and the inactive area;
detecting a user input and determining whether the user input began in the active area or the inactive area wherein in response to the detection of a user input beginning in the active area, a first function is performed and in response to the detection of a user input beginning in the inactive area the first function is not performed; and wherein the location of the active area is invariant with respect to performance of the first function.

14. A method as claimed in claim 13 wherein the display area comprises the entire touch sensitive display.

15. A method as claimed in claim 13 wherein the content displayed in the display area does not provide an indication of the first function.

16. A method as claimed in claim 13 comprising enabling a second function to be performed in response to the detection of a user input beginning in the inactive area of the touch sensitive display.

17. A method as claimed in claim 13 enabling a further active area of the touch sensitive display to be provided such that in response to the detection of a user input beginning in the further active area a third function is performed.

18. A method as claimed in claim 17 wherein the third function is the reverse of the first function.

19. A method as claimed in claim 13 wherein at least one of the functions comprises changing the scale of the content displayed in the display area.

20-24. (canceled)

25. A physical entity embodying a computer program comprising computer program instruction means configured to control an apparatus, the apparatus comprising a touch sensitive display and at least one processor the program instructions enabling, when loaded into the at least one processor;
configuring the touch sensitive display to provide an active area of the touch sensitive display and an inactive area of the touch sensitive display;
configuring the touch sensitive display to provide a display area of the touch sensitive display configured to display content where the display area overlaps at least a portion of the active area and the inactive area:
detecting a user input and determining whether the user input began in the active area or the inactive area wherein in response to the detection of a user input beginning in the active area, a first function is performed and in response to the detection of a user input beginning in the inactive area the first function is not performed; and wherein the location of the active area is invariant with respect to performance of the first function.

26-32. (canceled)
